(19) United States
(12) Patent Application Publication
(10) Pub. No.: US 2015/0187183 A1
(43) Pub. Date: Jul. 2, 2015

(54) Chance Event Occurrence Tracking And Visual Confirmation System, And Method Thereof

(71) Applicant: Create Technologies, Inc., Carson City, NV (US)

(72) Inventor: Nicholas P. De Luca, Carmel-by-the-Sea, CA (US)

(73) Assignee: Create Technologies, Inc., Carson City, NV (US)

(21) Appl. No.: 14/145,881

(22) Filed: Dec. 31, 2013

(51) Int. Cl. G07F 17/32

(52) U.S. Cl. CPC G07F 17/3286

(57) ABSTRACT

A method for monitoring a chance event is described. The method includes: capturing an initial ancillary frame image prior to an occurrence of a chance event, wherein the initial ancillary frame records winning outcomes based on the chance event; calculating motion information of an object in a reference frame, wherein the motion of the object defines the chance event; and capturing a final reference frame image when the chance event has occurred in the reference frame.

### BACKGROUND

In industries, such as, the gaming industry the monitoring of gaming events is vital to ensure, for example, fairness, accuracy and the prevention of theft, or false recording. Most games of chance use a random event, such as, a motion of one object with respect to a secondary reference frame, a shuffling of playing card, or the like. For example, a roulette table involves a spinning wheel and a spinning ball, a “wheel of fortune” uses a spinning wheel and a stationary pointer, and “craps” involves throwing dice and a stationary table. In many of these types of games, accurately determining the speed at which an object moves is generally very difficult. This difficulty leads to discrepancy and conflict which requires the tedious task of reviewing recorded film sequences at slow motion. In the case of a casino, this down time is expensive and leads to further loss of profit associated with potentially disgruntled customers.

One method of trying to ensure the accuracy of “on the spot” determinations involves building gaming systems that use auxiliary systems including encoders, radio frequency transmitters, or bar coding techniques. These systems are only partially effective as they generally work for only some or a portion of the gaming equipment. For example, it is difficult to use an auxiliary system on the moving balls as they move too quickly. Also, many gaming institutions would prefer to avoid the purchase of new gaming systems, such as, roulettes if possible and would prefer to monitor without changing the existing equipment. The integration of radio frequency systems into the tables is also expensive and difficult, and due to antennae interference not generally accurate. The use of high definition systems for recording the play action at a gaming station can be useful but requires human review of the video. In the case of large casinos with hundreds of cameras this becomes as very difficult task. Some gaming systems have been developed that are completely digital yet these systems lack the tactile nature that is desired.

### SUMMARY

Disclosed are a method and a system for monitoring the movement of a chance event, or two or more chance events and associated movement of ancillary objects. The monitoring can be with respect to separate or similar reference frames such that the movement of all objects can be easily correlated and compared. The monitoring of the movement of two or more chance events and associated movement of ancillary objects can be performed simultaneously.

In exemplary embodiments, the system and method are particularly useful in the gaming industry for monitoring, recording, and matching random events to ancillary events with a moving object, a moving reference frame or both a moving object and a moving reference frame through the use of a camera, a computer, a reporting system, a network, a coded object, and a vision recognition system. The system and the method can include a module for the correlation of a matched event to a secondary motion with a confirmation reporting system.

In exemplary embodiments, a method for monitoring a chance event may include: capturing an initial ancillary frame image prior to an occurrence of a chance event, wherein the initial ancillary frame records winning outcomes based on the chance event; calculating motion information of an object in a reference frame, wherein the motion of the object defines the chance event; and capturing a final reference frame image when the chance event has occurred in the reference frame.

It is to be understood that both the foregoing general description and the following detailed description are exemplary and explanatory and are intended to provide further explanation of the invention as claimed.

### BRIEF DESCRIPTION OF THE FIGURES

The accompanying drawings, which are included to provide a further understanding of the invention and are incorporated in and constitute a part of this specification, illustrate embodiments of the invention, and together with the description serve to explain the principles of the invention.

FIG. 1 illustrates a system including a data collection system, an information reporting system, a broadcasting system and a camera configured to view a chance event, a plurality of reference frames and a motion of an ancillary object according to exemplary embodiments.

FIG. 2 is a process flow diagram according to exemplary embodiments.

FIGS. 3A-3E illustrates a reference frame for a chance event and an ancillary reference frame depicting an associated numerology mapping to the reference frame according to exemplary embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DESCRIPTION OF EMBODIMENTS

Exemplary embodiments will now be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. Various changes, modifications, and equivalents of the systems, apparatuses, and/or methods described herein will likely suggest themselves to those of ordinary skill in the art. Elements, features, and structures are denoted by the same reference numerals throughout the drawings and the detailed description, and the size and proportions of some elements may be exaggerated in the drawings for clarity and convenience.

Additional features of the invention will be set forth in the description which follows, and in part will be apparent from the description, or may be learned by practice of the invention.

A method for monitoring an event in which an object is intended to randomly match with a base reference frame and in which said reference frame is moving with respect to the object is disclosed. When or at the point of matching of the object and the reference frame, for example, when both the object and the reference frame have the same position and/or velocity, an external descriptor consisting of a matched sequence is correlated to provide the correct value or descriptor of the event. The matching can be captured by a camera, and images captured by the camera can be processed by a computer. The correlation may include a match of color, shape, size, texture, topography, and character.

In exemplary embodiments, monitoring of an ancillary event, such as, the motion of an indicator or secondary object to the corresponding value detected from the match event can be accomplished using cameras and by storing the matching information within a computer system. The indicator or secondary object generally includes a physical object, such as, a token piece moved to indicate the outcome and placed on a table or board.

In exemplary embodiments, the process for monitoring and displaying potential errors in human perception, vocalization, token movement, and bet acknowledgement of the matched event is accomplished using visual analytic techniques, sound and voice recognition, as well as auxiliary electronic system. The reporting of these errors can be displayed in real-time or the information can be stored along with a video, photograph, or other recording of the discrepancy event.

In exemplary embodiments, the system or process may appropriately visually skewing the reference frames so as to be able to view the entire game area with a single camera and further correlate to a map of the reference frame.

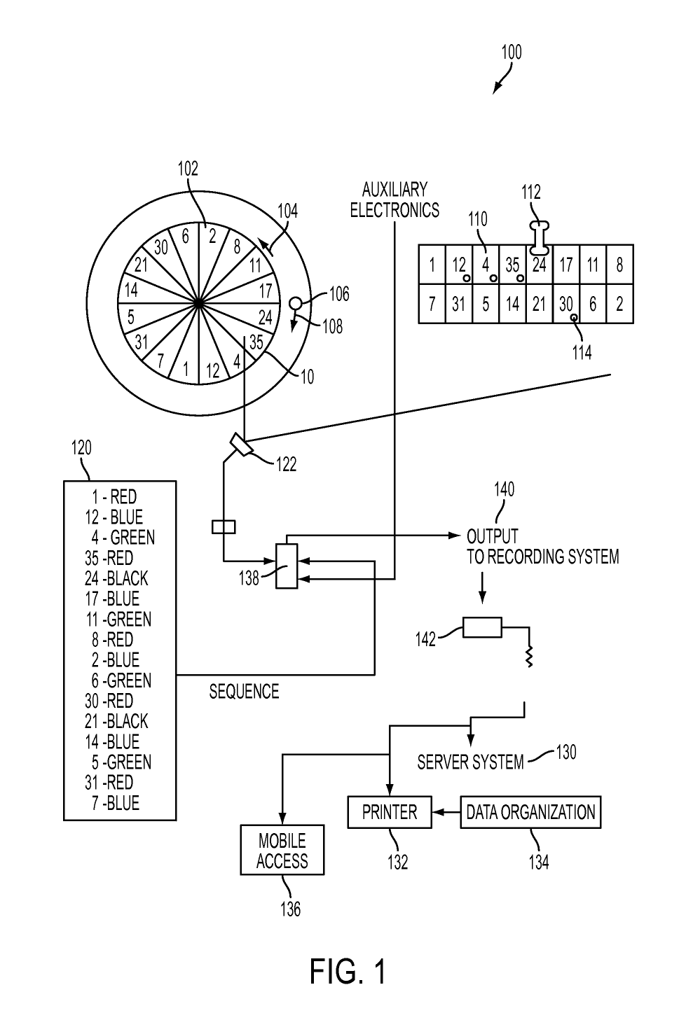

FIG. 1 illustrates a system including a data collection system, an information reporting system, a broadcasting system and a camera configured to view a chance event, a plurality of reference frames and a motion of an ancillary object according to exemplary embodiments.

A system 100 including a data collection system 138, an information reporting system 142, a broadcasting system 140 and a camera 122 configured to view a chance or non-deterministic event. The chance event can be captured by the camera 122 in a reference frame 102. The reference frame 102 can be provided by a roulette wheel. The reference frame 102 may be mapped to an ancillary reference frame 110, here illustrated as a roulette layout 110. The reference frame 102 may include a plurality of reference frames. The ancillary reference frame 110 may include a plurality of ancillary reference frames. An object or ancillary object 106 can be in motion with reference to reference frame 102.

Generally, roulette is a game where players may choose to place bets on either a single number or a range of numbers, the colors red or black, or whether the number is odd or even. The bets are placed on the roulette layout 100 using a gaming chip 114. To determine the winning number and color, a dealer or croupier spins the roulette wheel 102 in one direction 104, and then spins a ball or object 106 in the opposite direction 108 around a tilted circular track running around the circumference of the roulette wheel 102. The ball 106 eventually loses momentum and falls onto the wheel 102 and into a slot or pocket 109 on the roulette wheel 102. Generally, the roulette wheel 102 can include 37 (in French/European roulette) or 38 (in American roulette) colored and numbered pockets 109 on the wheel 102. An exemplary key or associated numerology 120 may define various properties of a pocket 109.

Roulette players have a variety of betting or gaming options. Placing inside bets is either selecting the exact number of the pocket 109 the ball will land in, or a small range of pockets 109 based on their proximity on the layout. Players wishing to bet on the ‘outside’ will select bets on larger positional groupings of pockets 109, the pocket color, or whether the winning number is odd or even. Generally, the payout odds for each type of bet are based on its probability.

Players can continue to place bets as the ball 106 spins around the wheel 102 until the dealer announces no more bets. When a winning number and color is determined by the ball 106 dropping into a pocket 109 of the roulette wheel 102, the dealer will place a marker 112, also known as a dolly, on that winning number on the roulette table layout 110. When the marker 112 is on the layout or ancillary reference frame 110, no players may place bets, collect bets, or remove any bets from the table. The dealer may then sweep away all other losing bets either by hand or rake, and determine all of the payouts to the remaining winning bets. When the dealer is finished making payouts, the marker 112 is removed from the layout or ancillary reference frame 110 where players collect their winnings and make new bets. The winning chips remain on the layout or ancillary reference frame 110.

Images captured by camera 122 may be preprocessed and provided to the data collection system 138 including a processor, data storage, memory and the like. Images captured by camera 122 may be broadcast using a broadcasting system 140. The broadcasting system may be used by security personnel for monitoring players, dealers, and other persons. Data and images may be managed, used and manipulated by the information reporting system 142. The information system 142 can provide the images and data to a server system 130. The server system 130 can include a printer 132 or a display. The server system 130 can organize the data using a data store 134 or the like. Access to the server system 130 can be provided by a mobile access system 136. The mobile access system 136 can provide web-access or the like.

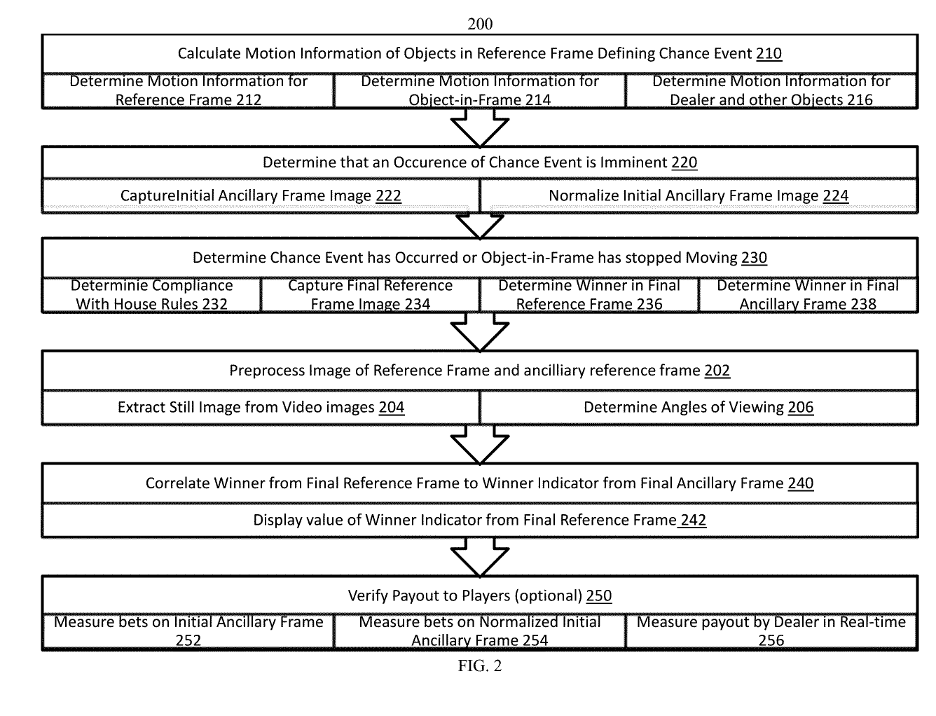

FIG. 2 is a process flow diagram according to exemplary embodiments. A process 200 for monitoring the movement of a chance events and associated movement of ancillary objects, and correlating and comparing the chance events in two or more separate or similar reference frames is described according to exemplary embodiments.

Process 200 may include calculating motion information of an in-motion object captured as a video or still image by the camera 122 in operation 210, wherein a motion of the object or a stopping of the motion of the object defines a chance event. Operation 210 may include determining motion information for the reference frame in operation 212, for example, determining that the roulette wheel 102 is in motion when the dealer announces no more bets to the players. Operation 210 may include determining motion information for object-in-frame in operation 214, for example, determining that the ball or object 106 is in motion when the dealer announces no more bets to the players. Operation 210 may include determining motion information for a dealer and other objects in operation 216. A dealer may establish “No more bets,” “exchanging cash for chips,” “Paying winning chips,” and the like with various motions made on field of view of the camera 122. For example, the dealer can make a different hand gesture or signal to establish or communicate a state of the game or action being performed by the dealer.

Process 200 may include determining that an occurrence of a chance event is imminent, for example, when a dealer has stopped betting in operation 220 with a hand gesture, an audible, or an input device to signal a monitoring system 138. The input device can include a remote control, a press of a button, a keyboard, or the like. Operation 220 may include establishing an initial ancillary frame in operation 222, for example, by capturing or extracting a still image when a dealer has stopped further betting on the current spin of the roulette wheel 102 or ball 106. Operation 220 may include normalizing an initial ancillary frame in operation 224, for example, by calculating a plan view, for example, a top-plan view, of the established captured or extracted still image of the ancillary reference frame or layout 110.

Process 200 may include determining that an object-in-frame has stopped moving in operation 230. Operation 230 may include determining compliance with various house rules in operation 232, for example, did object-in-motion meet navigating requirement in operation, were bets placed, removed or altered after the dealer stopped the betting, or the like. Operation 230 may include establishing a final reference frame in operation 234, for example, capturing or extracting a still image when he current spin of the roulette wheel 102 and ball 106 have stopped. Operation 230 may include determining a winner in the final reference frame in operation 236, for example, determining what pocket the ball 106 fell into. Operation 230 may include determining a winner in final ancillary frame in operation 238, for example, by determining where the marker 112 has been placed on the layout 110 by the dealer.

Process 200 may include preprocessing images captured by a still or video image recording a chance or non-deterministic event, for example, with camera 122 in operation 202. The capturing can include an image capture of a reference frame, for example, an image of the roulette wheel 102. The capturing can include an image capture of an ancillary reference frame, for example, an image of the layout 110. Process 200 may include extracting a still image from a video image or stream in operation 204. Process 200 may include determining angles of viewing by the camera 122 in operation 206. Operation 206 may include determining an angle of viewing for a base reference frame. Operation 206 may include determining an angle of viewing for an ancillary reference frame. The angle of viewing for a base reference frame and/or the angle of viewing for an ancillary reference may be used to normalize a still or video image of the reference frame and the ancillary frame captured by the camera 122.

Process 200 may include correlating a winner from the final reference frame, for example, the roulette wheel 102, to the winner indicator placed or disposed in the final ancillary frame, for example, the position of the marker 112. In operation 240, the correlating can include verifying the position of the marker 112 on the layout 110. Operation 240 may include displaying a winner indicator from as determined by the chance event captured in the final reference frame 242, for example, a display can display a pocket number of where the ball 106 stopped by chance.

In exemplary embodiments, process 200 may include verifying payout to players in operation 250. Operation 250 can include measuring bets on the initial ancillary frame in operation 252, for example, the value of chips 114 on the layout 110. Operation 250 can include measuring bets on the normalized initial ancillary frame in operation 254. Operation 250 can include measuring a payout by a dealer in real-time in operation 256.

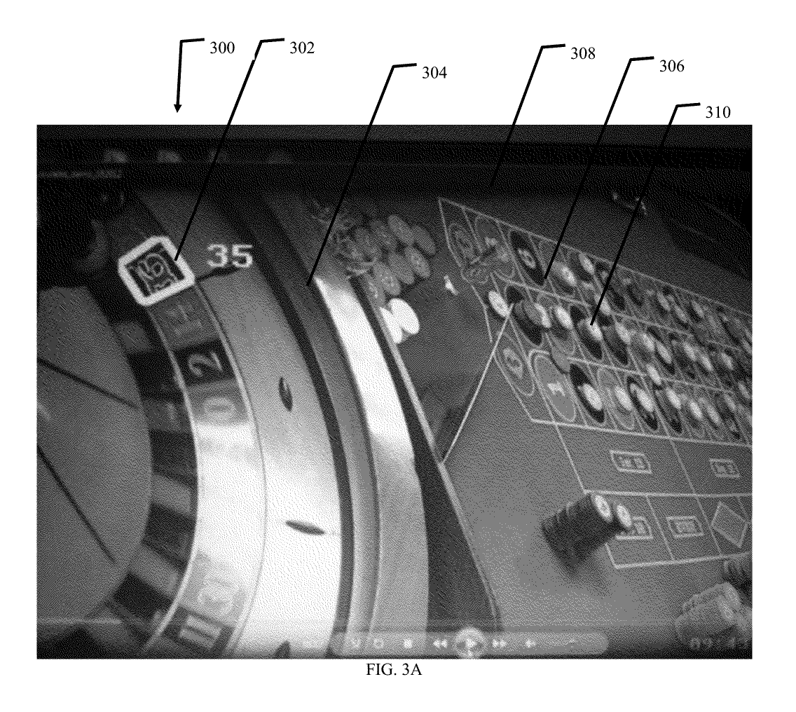

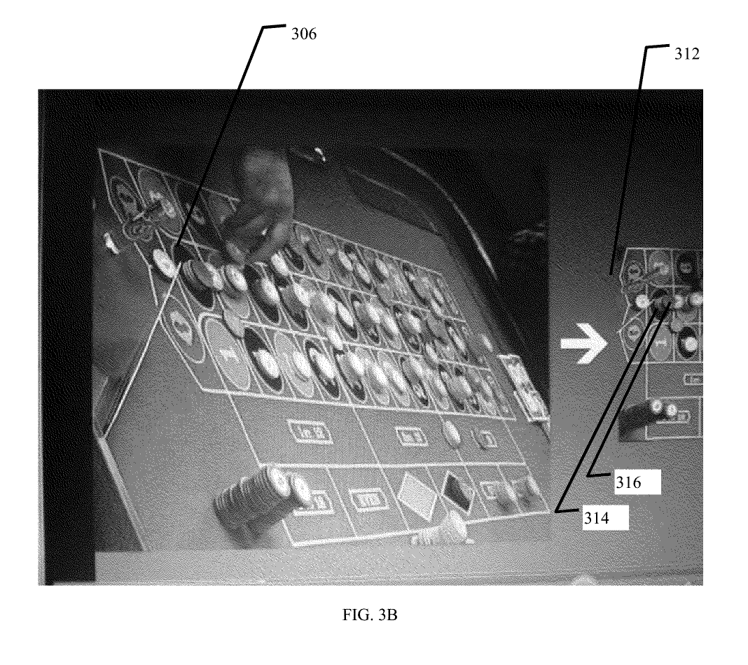

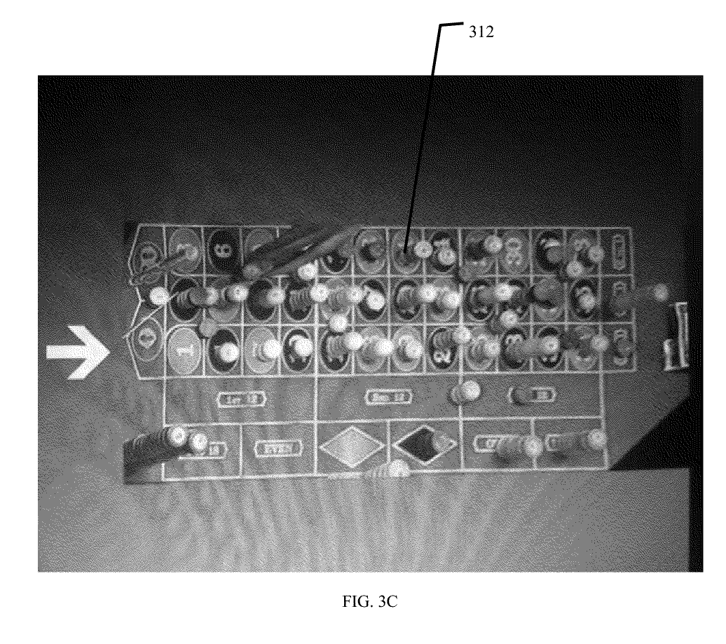

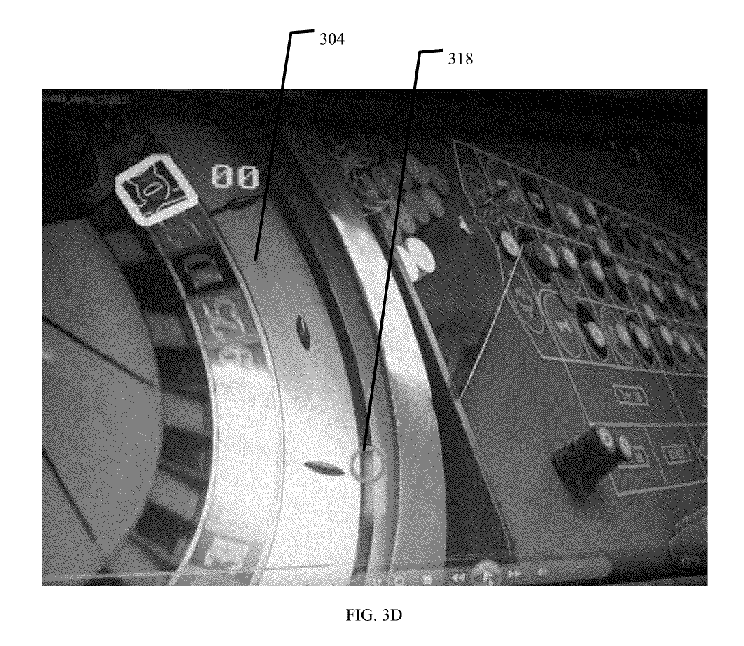

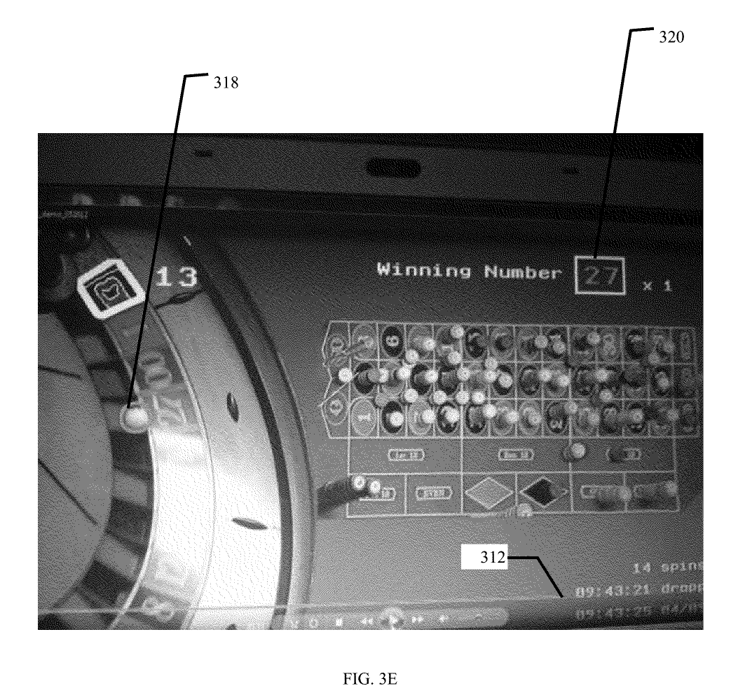

FIG. 3A illustrates a reference frame or roulette wheel for a chance event and associated numerology mapping or layout to the reference frame according to exemplary embodiments. For example, in a roulette game 300 a pocket 302 labeled 35 and colored black can be provided in a reference frame or roulette wheel 304. An ancillary reference frame or layout 306 on a board 308 can be disposed adjacent the roulette wheel 304. Bets can be placed on ancillary reference frame or layout 306 using gaming chips 310.

FIG. 3B illustrates the ancillary reference frame or layout 306 associated with the roulette game 300 and a transformation of the ancillary reference frame or layout 306 to generate a normalized ancillary reference frame 312. The normalized ancillary reference frame 312 may be used to measure or count the gaming chips 310 placed on the ancillary reference frame or layout 306 according to exemplary embodiments. The normalized ancillary reference frame 312 may be used to measure different value gaming chips 314 and 315 by correlating a gaming chip color or edge to a value. The normalized ancillary reference frame 312 may be used to measure a height or number of different value gaming chips 314 and 315.

FIG. 3C illustrates a top down view of a fully transformed ancillary reference frame 312 according to exemplary embodiments.

FIG. 3D illustrates an in-motion found object or blur 318 (appearing as a blur) and an associated reference frame or roulette wheel 304 for a chance event according to exemplary embodiments.

FIG. 3E illustrates a capture and determination of a chance event and a correlation to an ancillary movement on a reference frame where chips are located according to exemplary embodiments. In this example, the ball or object 318 has dropped into the pocket labeled 27 and colored red. The system can correlate the pocket where the ball 318 dropped to an indicator 320. In this example, the indicator 320 can display the number of the winning pocket, i.e., 27. The display of the camera can also indicate or display auditing data 322. For example, the auditing data 322 may display a count of spins made (for example, by the current dealer), a time of the last object or ball 318 drop. The auditing data 322 can also display a current timestamp. In exemplary embodiments, a motion of the chip handler may be monitored to ensure that the proper logistics, for example, a payout of the bets, are enacted based on the correlation.

In exemplary embodiments, the chance events may be monitored with ease from a single vantage point.

In exemplary embodiments, the reference frames may be easily monitored correlated or assigned to a map.

In exemplary embodiments, the monitoring system may be capable of inferring the characteristics of the reference frames and objects; for example, the color, size, shape, geometry, and morphology.

In exemplary embodiments, the monitoring system may be capable of referencing to the monitored chance events electronic signals, such as, audio and/or visual data transmitted, collected or received by an existing gaming system.

In exemplary embodiments, the monitoring system may be capable of monitoring the movement profile of an object with respect to a reference frame.

In exemplary embodiments, the monitoring system may record and display on a real-time basis the value associated with a chance event and the correct or incorrect movement of a secondary object to a secondary reference frame wherein the position of the secondary object is supposed to reflect the position of the object within the chance event reference frame.

In exemplary embodiments, the monitoring system may be capable of actuating a warning system on a real-time basis if the value associated with a chance event is not correlated correctly to the movement of a secondary object in a secondary reference frame.

In exemplary embodiments, the monitoring system may be capable of alerting that a player is collecting their winnings and betting chips until all of the winnings in the same box (e.g., all bets and winnings on ‘red’) have been paid. This alert can avoid confusion and minimize the chance for a player to steal other players' chips.

In exemplary embodiments, the monitoring system may be capable of alerting that a player is touching chips after the dealer gives the hand signal or announces “no more bets”. This alert can ensure that players are not removing, changing or adding bets past this point.

In exemplary embodiments, the monitoring system may be capable of alerting that a player is touching any chips on a winning chance when the dealer has placed the dolly (the plastic marker used to mark the winning number). In exemplary embodiments, the monitoring system may strictly prohibit touching any chips on a winning chance by a player.

In exemplary embodiments, the monitoring system may be capable of alerting that a dealer is not allowed to take money to change for chips from a player's hand. If the player wishes to get more chips, he or she must place the money on the layout of the table.

The examples presented herein are intended to illustrate potential and specific implementations. It can be appreciated that the examples are intended primarily for purposes of illustration for those skilled in the art. The diagrams depicted herein are provided by way of example. There can be variations to these diagrams or the operations described herein without departing from the spirit of the invention. For instance, in certain cases, method steps or operations can be performed in differing order, or operations can be added, deleted or modified.

What is claimed is:

1. A method for monitoring a chance event, the method comprising:
capturing an initial ancillary frame image prior to an occurrence of a chance event, wherein the initial ancillary frame records winning outcomes based on the chance event;
calculating motion information of an object in a reference frame, wherein the motion of the object defines the chance event; and
capturing a final reference frame image when the chance event has occurred in the reference frame.

2. The method of claim 1, further comprising determining that the chance event has occurred.

3. The method of claim 1, further comprising determining that an occurrence of a chance event is imminent.

4. The method of claim 1, wherein the chance event is monitored from a single vantage point.

5. The method of claim 1, further comprising correlating or assigning the final reference frame image to an ancillary reference frame.

6. The method of claim 1, further comprising inferring the characteristics of a reference frame and an object in the reference frame, wherein the characteristics comprise one or more of a color, size, shape, geometry, and morphology of the object or the reference frame.

7. The method of claim 1, wherein the capturing of the initial ancillary frame image and the capturing of the final reference frame image comprises audio and/or visual data transmitted, collected or received by an existing gaming system.

8. The method of claim 1, wherein the calculating of the motion information comprises monitoring a movement profile of the object with respect to the reference frame.

9. The method of claim 1, further comprising storing in real-time an outcome of the chance event; and
verifying a placement of a secondary object in an ancillary reference frame, wherein the placement of the secondary object is reflects the outcome of the chance event within the reference frame.

10. The method of claim 1, further comprising displaying on a display an outcome of the chance event in real-time.

11. The process of claim 1, further comprising actuating a warning system in real-time the outcome of the chance event is not correlated correctly to the movement of a secondary object in an ancillary reference frame.

12. The method of claim 1, wherein the reference frame image comprises an image of a roulette wheel in real-time.

13. The method of claim 1, wherein the ancillary reference frame image comprises an image of a roulette layout.
